(19) United States
(12) Patent Application Publication
(10) Pub. No.: US 2009/0297871 A1
(43) Pub. Date: Dec. 3, 2009

(54) Wood Impregnation

(76) Inventors: Steve Crimp, Auckland (NZ); Terence Paul Smith, Auckland (NZ)

Correspondence Address: JACOBSON HOLMAN PLLC, 400 SEVENTH STREET N.W., SUITE 600, WASHINGTON, DC, 20004, US

(21) Appl. No.: 12/083,235

(22) PCT Filed: Sep. 26, 2006
(86) PCT No.: PCT/NZ2006/000249

§ 371 Date: Jul. 27, 2009

(30) Foreign Application Priority Data
Oct. 19, 2005 (NZ) 543124

(51) Int. Cl. B32B 21/04; B05D 3/00; B05D 3/02

(52) U.S. Cl. 428/537.1; 427/297; 427/317

(57) ABSTRACT

A process for treating dimensioned wood, dimensioned lumber or dimensioned timber (‘timber’) or veneer or particle based products or reconstituted wood products or other cellulosic materials (‘product’), said process comprising or including impregnating the timber or product to its core with a water based biocidal and/or other water based composition (‘preservative’) whereby the uptake is less than 80 L/m³. The process includes pressure variations.

### TECHNICAL FIELD

The present invention relates to a process for preserving wood and cellulosic products (e.g. reliant on a biocidal active or biocidal actives to prevent fungal decay and/or insect damage).

### BACKGROUND ART

Impregnation procedures for wood, lumber or timber (“timber”) has usually involved an impregnation procedure where the active agent, or a precursor of an active agent, is carried in a liquid carrier. Sometimes the liquid carrier is water or water based. Sometimes the liquid carrier is an organic solvent or organic solvent based or maybe an inorganic solvent or inorganic solvent based.

The well known LOSP procedure is a solvent based procedure which has the usual difficulties when handling solvent i.e. environmental consideration in respect of emissions, flammability etc. The LOSP procedure however has an advantage in that it does not add moisture back into the timber. Excessive moisture uptake can affect dimensions of timber.

Water based systems have been perceived as requiring a significant uptake of any water based treatment composition in order to provide the required penetration through to the core of the timber being treated. This has resulted in an increase of the moisture content of the timber which has an effect on the dimensional stability of the timber and may also require that the timber be redried prior to use.

The present invention recognises an advantage to be obtained from the reliance upon a water based treatment composition that nonetheless meets standards of active ingredient penetration but which nonetheless, owing to a low uptake of water, still provides a dimensional stability of the timber preferably substantially at the dimensions prior to the treatment.

It is recognised that a procedure with effective penetration can be obtained for a variety of different biocidally effective active agents having an antifungal or other biocidal role reliant surprisingly upon shorter exposure times (e.g. of a soak (pressure) step whether above atmospheric or at atmospheric following an applied vacuum) uptakes of less than 80 L/m³ (and preferably less than 40 L/m³) to yield a moisture content of the just treated timber of less than 25% and preferably less than 20% (w of water/w of oven dried timber).

The present invention recognises many different actives can be carried into the wood of timber or lumber without a need for resins and/or curing agents in the water or water based liquid carrier. The present invention recognises an option of including a wetting agent and/or surfactant.

Preferred actives include fungicides, insecticides and those to discourage termites.

### DISCLOSURE OF INVENTION

In one aspect the invention is a process for treating dimensioned wood, dimensioned lumber or dimensioned timber (“timber”) or veneer or particle based products or reconstituted wood products or other cellulosic materials (“product”) said process comprising or including impregnating the timber or product to its core with a water based biocidal or other composition (preferably using at least one vacuum cycle and preferably over a controlled composition exposure time or over controlled composition exposure times) whereby less than 80 L/m³ of composition uptake is achieved.

The wood, timber, or content of the product may be of any species but is preferably of a pine preferably selected from the group Radiata, Slash, Hoop and Southern Yellow, Parana, and Brazilian.

While the uptake may exceed 40 L/m3, preferably the uptake is less than 40 L/m³.

The initial step (preferably) may be either a vacuum step of between 0 and −50 kPa or a pressure (air pressure) step of between 0 and 100 kPa. Either the vacuum or pressure preferably should be held for between 0 and 10 minutes.

Preferably the wood, timber or product prior to the at least one vacuum cycle is at a moisture content of less than 30% and more preferably less than 20% w water/w dry timber. The timber can have been subject to kiln or other drying such that the moisture is at that level but the treatment will work on material that has a moisture content of less than 30% w water/w dry timber.

Preferably the composition comprises or includes
water as at least the primary liquid carrier
optionally at least one other liquid
optionally a wetting agent or surfactant (e.g. amine oxides)
at least one biocidal (e.g. antifungal or insecticidal) or other timber protecting agent dissolved in, suspended in and/or emulsified in the water carrier.

The concentration of the treatment solution is preferably set at such a level that at the end of the treatment cycle, based on the uptake of solution achieved by the cycle used, the retention of the active ingredients is higher than the minimum level required to prevent timber degradation by decay or insects/termites as appropriate, e.g. in the case of the borate/boric acids solution, a solution concentration of about 16% m/v (Boric Acid Equivalence-BAE basis) with an average uptake of 40 L/m3 to ensure at least the required retention level of 0.4% m/m as required by NZS 3640.

The time the solution is in contact with the wood will vary depending on the uptake required but is typically 1-10 minutes.

The mandatory content of the solution is that the majority solvent component be water and a fungicide or insecticide, or both.

The preservative is made available to the wood at pressures between −50 kPa and +100 kPa.

During the filling of the vessel it may be beneficial to compensate for the increasing hydrostatic head, e.g. if the charge height is 1.2 m high and the fluid specific gravity is 1.10, there would need to be a 13 kPa reduction in air pressure during filling to offset this.

The treated timber should at the completion of the treatment process have a moisture content of less than 25% but ideally less than 20%. Dimensional changes should be no greater than 2 mm in either cross-sectional dimension.

Preferably the wood, timber or product after impregnation is at a moisture content of less than 20% w water/w dry timber.

The timber can be of any suitable cross-sectional dimensions.

A vacuum may be applied or reapplied when the timber is no longer exposed to the composition. This is not a critical step in the process. A final vacuum of anywhere between 0 and −95 kPa held for anywhere from 0-60 minutes could be used.

In another aspect the invention consists in a method of protecting wood, lumber, timber or cellulosic materials (e.g. such as timber previously described) which comprises or includes

subjecting the material to be treated to at least a partial vacuum,

exposing the material to an aqueous treatment composition at a pressure or pressures of at least about atmospheric pressure or above, and

(optionally) subjecting the material, when no longer to external exposure to such composition, to at least a partial vacuum,

wherein the exposure is such that there is an uptake of less than 80 L/m³ of the aqueous composition (more preferably less than 40 L/m³).

Preferably said composition is biocidal and preferably comprises an antifungal species in a water carrier (which optionally may includes at least one other liquid and may include a wetting agent or surfactant, the liquid composition preferably no including any resin nor curing agent).

Preferably the exposure is a single exposure but can be multiple exposures (e.g. after pressure reductions, etc).

Preferably the fungicidal active is a boron based active, CCA, ACQ, azoles including tebuconazole, propiconazole, cyproconazole, prochloraz and other triazoles, oxine copper IPBC, tributyltin, copper compounds and zinc compounds in either solution form or suspended particle form, copper or zinc naphthenate or the like and may be any combination of any such actives.

Preferably the insecticidal active is a synthetic pyrethroid such as permethrin, deltamethrin, cypermethrin or bifenthrin or other such insecticides such as imidachloprid, fipronil and chloropyrofos and may be any combination of any such actives or in combination with any fungicide.

In one preferred form of the present invention the material being treated is dimensioned wood, dimensioned lumber or dimensioned timber and the resultant moisture content is less than 20% w water/w dry timber after treatment so as to maintain the dimensions of the material treated to substantially those immediately prior to treatment.

Preferably the material being treated both prior to and post exposure is at less than 20% w water/w dry timber.

Optionally the active is a boron active, such as is appropriate for framing.

Preferably the impregnation is of a conifer species wood and preferably a pine. Preferred pines are Radiata, Slash, Hoop, Parana, Brazilian and Southern Yellow. The produce may be used with another conifer (e.g. Douglas fir or spruce) but we prefer the procedure for pines and particular the pine types specified.

Alternatively if the impregnation is with an ACQ active the loading is to achieve the H3 loading of about 0.45% in/m in the cross section.

Preferably the concentration of active and the actives chosen for the load uptake of liquid which is the carrier therefor will result in retention levels of the active(s) in the material above the minimum required to protect the timber against decay, insect and, where required, termite attack. Accordingly the examples hereinafter discussed with respect to boron and ACQ are merely illustrative.

Preferably the formulation does not include any resins or curable agents. The procedure is preferably merely one whereby there is transport into the material being treated of the requisite biocidal active.

The treatment conditions are preferably determined by the up take and concentration of actives so that a required penetration is achieved.

The invention is also product or timber that has been subject to a method of the present invention.

As used herein “dimensioned” means or includes at least of a cross section of desired dimensions.

As used herein “biocidal” includes species of active(s) able to discourage degradation whether by fungal entities, insects, etc.

As used herein the term “and/or” means “and” or “or”, or both.

As used herein the term “(s)” following a noun includes, as might be appropriate, the singular or plural forms of that noun.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

The present invention will now be described with reference to the following examples and drawings.

### BRIEF DESCRIPTION OF DRAWING

In the drawing in which FIG. 1 is a plot of Pressure against Time for a preferred embodiment of the process.

We have developed a treatment cycle that enables the use of waterborne preservative systems to achieve low full sapwood penetration in kiln dried timber with uptakes preferably less than 40 L/m3.

Previously only LOSP (white spirits based) preservative systems have been used at such low uptakes and still achieve full sapwood penetration. Traditionally water borne preservative systems have required uptakes of >100 L/m3 and more often >200 L/m3 to meet the sapwood penetration requirements.

We have developed a system that enables the use of low uptake cycles with water borne systems thus enabling us to achieve the benefits of LOSP systems (no or little timber swelling during treatment and no or little increase in moisture content) with the benefits of a water based system (no solvent odour, and no hold times after treatment prior to dispatch or painting).

FIG. 1 represents outlines the basics of the treatment cycle:

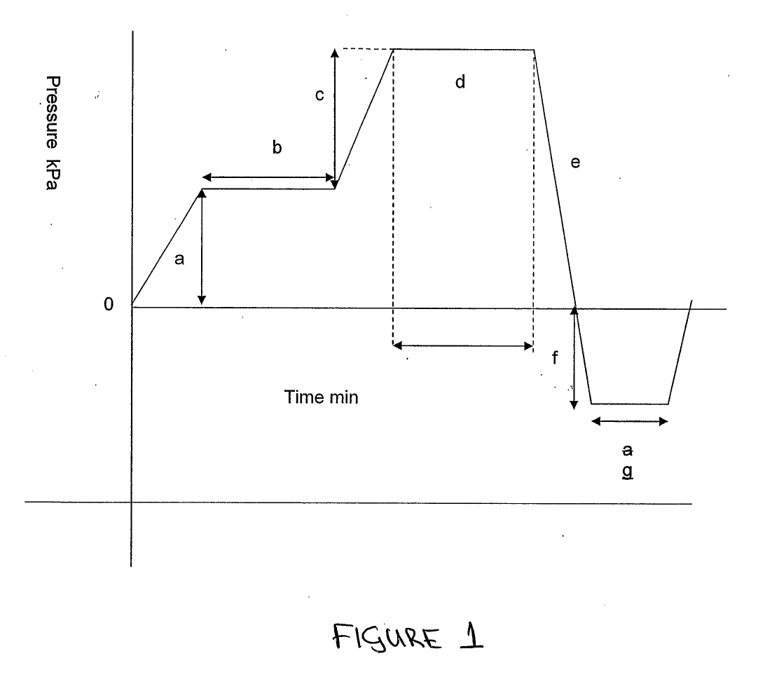

In FIG. 1 there is depicted
(a) The initial vacuum or air pressure to which the timber or other material is exposed to
(b) The length of time for which the initial vacuum or air pressure is held and during which time the preservative is pumped into the cylinder
(c) The increase in pressure (hydraulic)
(d) The length of time for which the pressure is held
(e) Emptying of cylinder either by pumping out or gravity
(f) Final vacuum level of between 0 and −95 kPa
(g) Length of final vacuum

The system preferably involves the use of specific treatment cycles and/or preferably involves use of surfactants/wetting agents in the preservative solution to enable the low uptake cycles to achieve the full sapwood penetration of preservative required.

Preservative system: Preservative systems that are water based or whose predominant solvent component is water. Specifically boron containing systems can be employed. Other systems such as boron based active, CCA, ACQ, azoles including tebuconazole, propiconazole, cyproconazole, prochloraz and other triazoles, oxine copper IPBC, tributyltin, copper compounds and zinc compounds in either solution form or suspended particle form, copper or zinc naphthenate or the like and may be any combination of any such actives can also be employed.

The preservative system may, but not essentially, contain a suitable wetting agent or surfactant at a level between 0.1 and 20% by weight.

The preservative system may be heated or used at ambient temperature.

The treatment cycle used preferably should be:
Initial vacuum/pressure step. Pressure to be between −50 kPa and 100 kPa and held for a period of time (e.g. 2 minutes).
Flood vessel under the vacuum or pressure level used initially.
Release vacuum/pressure to atmospheric and allow timber to soak for between 1 and 60 minutes or optionally apply hydraulic pressure up to 200 kPa.
Empty vessel.
Final vacuum of any level held for between 0 and 60 mins.
Release vacuum and drain cylinder.

The wood that is to be treated can be any species and should be conditioned to a moisture content of less than 30%. Final preservative uptake in the wood will be less than 80 L/m3 but ideally less than 40 L/m3.

All product treated by the aforementioned specification is also covered.

### EXAMPLE 1

Pre-cut studs 2.330 m long 90×45 mm were measured for original width and thickness using digital callipers. A diluted boron-glycol solution was prepared using Boracol 200RH and water; this contained 16% m/v boric acid equivalent (BAE) plus a red dye.

The process used was:
Draw initial vacuum and hold 2 minutes
Flood vessel under vacuum
Release vacuum to atmospheric and soak 2 minutes
Empty vessel using pump
Draw final vacuum −85 kPa and hold 15 minutes
Release vacuum and drain residual fluid

Some packs included a wetting agent (Silwet) at 0.67% v/v.

Packs were weighed before and after treatment using 3000 kg +/−1 kg calibrated weigh bars to allow uptake to be calculated. Solution density was taken as 1.14 g/mL.

10 samples per pack were taken immediately after treatment from the middle of the pack. These were measured for width and thickness using the digital callipers.

Samples were then analysed samples for boron loadings in cross-section and core of sapwood. This also included a penetration spot-test and determination of moisture content.

### Results

Net Uptake

| | | Initial | | Wetting | Net uptake |
|---|---|---|---|---|---|
| Charge | Pack | Vacuum | Strapping | Agent | L/m3 |
| 1 | A | −30 kPa | loose strap | none | 57 |
| 2 | B | −20 kPa | loose strap | none | 44 |
| 3 | C | −20 kPa | loose strap | SX | 41 |
| 4 | D | −20 kPa | orig strap | SX | 30 |
| 5 | E | −15 kPa | orig strap | SX | 26 |

Swelling

| | | Average Swell | | | | |
|---|---|---|---|---|---|---|
| | Untreated | A | B | C | D | E |
| Width | 90.6 mm | +1.9 mm | +1.4 mm | +0.6 mm | +0.2 mm | +0.6 mm |
| Thickness | 45.2 mm | +1.2 mm | +0.7 mm | +0.5 mm | +0.3 mm | +0.4 mm |

Retention (targeting 0.4% in cross-section, 0.04% in central 1/9^{th})

| | |
|---|---|
| Cross-section | Core |

| | | | |
|---|---|---|---|
| MC | % BAE m/m | MC | % BAE m/m |

Pack A

| | | | | |
|---|---|---|---|---|
| Mean | 16% | 2.09 | 11% | 1.48 |
| Minimum | 14% | 1.62 | 7% | 0.42 |
| Maximum | 20% | 2.85 | 15% | 3.01 |
| % Complying | | 100% | | 100% |

Pack B

| | | | | |
|---|---|---|---|---|
| Mean | 16% | 1.55 | 9% | 0.65 |
| Minimum | 12% | 1.18 | 7% | 0.11 |
| Maximum | 24% | 2.57 | 12% | 1.18 |
| % Complying | | 100% | | 100% |

Pack C

| | | | | |
|---|---|---|---|---|
| Mean | 16% | 1.19 | 13% | 0.63 |
| Minimum | 12% | 0.84 | 7% | 0.09 |
| Maximum | 19% | 1.58 | 16% | 1.42 |
| % Complying | | 100% | | 100% |

Pack D

| | | | | |
|---|---|---|---|---|
| Mean | 14% | 0.98 | 11% | 0.37 |
| Minimum | 10% | 0.21 | 7% | 0.00 |
| Maximum | 18% | 1.66 | 16% | 0.87 |
| % Complying | | 100% | | 80% |

Pack E

| | | | | |
|---|---|---|---|---|
| Mean | 11% | 0.69 | 12% | 0.30 |
| Minimum | 9% | 0.42 | 9% | 0.03 |
| Maximum | 14% | 1.01 | 13% | 0.78 |
| % Complying | | 100% | | 90% |

### EXAMPLE 2

Pre-cut studs 2.330 m long 90×45 mm were weighed before and after treatment. A solution containing ACQ and monoethyloene glycol or a standard ACQ in water solution such that the ACQ concentration was 5% m/v was used.

The process used was:
Apply initial pressure to +40 kPa and hold 2 minutes
Flood vessel under +40 kPa pressure
Increase pressure to 100 kPa and hold for 2 minutes
Empty vessel under gravity
Draw final vacuum −85 kPa and hold 15 minutes
Release vacuum and drain residual fluid

6 samples were taken immediately after treatment and weighed.

Samples were tested for copper penetration.

### Results

### Net Uptake

### (a) ACQ in MEG

| | Net uptake |
|---|---|
| Sample | L/m3 |
| 1 | 23 |
| 2 | 16 |
| 3 | 20 |
| 4 | 43 |
| 5 | 24 |
| 6 | 32 |

(b) ACQ in water

| | Net uptake |
|---|---|
| Sample | L/m3 |
| 1 | 42 |
| 2 | 32 |
| 3 | 47 |
| 4 | 41 |
| 5 | 68 |
| 6 | 41 |

### EXAMPLE 3

Pre-cut studs 2.330 m long 90×45 mm were used. A solution containing tebuconazole and propiconazole in a 1:1 ratio. The product is a microemulsion formulation commercially available as Protim E415 that not only contains the actives but also a number of surfactants and emulsifiers to emulsify the two azoles in the water based system. Two treatment cycles were trialed.

The process used was:
Apply initial pressure to +40 kPa in the first charge and +70 kPa in the second and hold 2 minutes
Flood vessel under +40 kPa and +70 kPa in the second treatment pressure
Increase pressure to 100 kPa and hold for 2 minutes
Empty vessel under gravity
Draw final vacuum −85 kPa and hold 15 minutes
Release vacuum and drain residual fluid

Samples from the charge were taken and the central 1/9^{th} of the boards analysed qualitatively to determine the presence of both the propiconazole and tebuconazole. In all cases the presence of both tebuconazole and propiconazole was detected in the central 1/9^{th} of the sapwood indicating full sapwood penetration.

### EXAMPLE 4

End sealed matched samples (500×90×45 mm) of untreated MGP12 Radiata Pine framing were prepared. Each charge contained 16 matched samples. A 9% m/v CCA solution was prepared from CCA Oxide.

The schedules used are shown below.

| Charge | Solution | Initial Pressure | Final Pressure | Differential |
|---|---|---|---|---|
| 1 | 9% CCA Oxide | 50 | 100 | 50 |
| 2 | 9% CCA Oxide | 100 | 130 | 30 |
| 3 | 9% CCA Oxide | 100 | 150 | 50 |
| 4 | 9% CCA Oxide | 100 | 180 | 80 |

Boards were weighed before and after treatment to allow uptake to be calculated.

6 samples were taken immediately after treatment and weighed.

Samples were tested for copper penetration.

### Results

A summary of the average uptake and dimension changes are shown below.

Schedule

| | | | |
|---|---|---|---|
| 50 100 | 100 130 | 100 150 | 100 180 |

Average Uptake (L/m3)

| | | | | |
|---|---|---|---|---|
| CCA | 67.1 | 56.0 | 75.9 | 97.9 |

Average Width Change (mm)

| | | | | |
|---|---|---|---|---|
| CCA | 2.5 | 2.3 | 2.9 | 3.0 |

Average Thickness Change (mm)

| | | | | |
|---|---|---|---|---|
| CCA | 1.1 | 1.1 | 1.2 | 1.2 |

Penetration**

| | | | | |
|---|---|---|---|---|
| CCA | Marginal | Fail | Pass | Pass |

**Pass = >90% of samples with complete sapwood penetration

Some Double Vac treatments were done using CCA solutions concentrations suitable to achieve the required retention based on the expected uptake of preservative using the various treatment cycles to establish whether complete penetration could be obtained. The width, thickness and uptake results are shown below:

| Schedule | Width | Thickness | Uptake | |
|---|---|---|---|---|
| Double Vac | (mm) | (mm) | l/m3 | Penetration |
| −15 | 1.711 | 0.902 | 49.7 | Fail |
| −20 | 2.457 | 1.102 | 60.3 | Fail |
| −25 | 2.437 | 1.097 | 66.1 | Fail |
| −30 | 2.513 | 1.089 | 71.2 | Fail |

The double vac process with CCA solutions shows increasing uptake with increasing pressure differential, however even at −30 kPa, with uptakes of 71 L/m3, penetration failed significantly.

1-47. (canceled)

48: A process for treating dimensioned wood, dimensioned lumber or dimensioned timber (“timber”) or veneer or particle based products or reconstituted wood products or other cellulosic materials (“product”), said process comprising or including impregnating the timber or product to its core using a pressure differential or pressure differentials (ie. vacuum/pressure and/or pressure/pressure) over one or more composition exposure time(s),
wherein the composition to which the timber or product is exposed for uptake is a liquid based composition having a effective biocidal and/or preservative action,
and wherein the liquid based composition is at least primarily water based but does include one surfactant or at least one other liquid,
and wherein the liquid uptake is less than 80 L/m³.

49: The process as claimed in claim 48 using at least one vacuum step.

50: The process as claimed in claim 48 wherein the wood, timber or content of the product is of a conifer.

51: The process as claimed in claim 50 wherein the conifer is a pine.

52: The process as claimed in claim 51 wherein the pine is selected from the group Radiata, Slash, Hoop and Southern Yellow.

53: The process as claimed in claim 48 wherein the uptake is less than 40 L/m³.

54: The process as claimed in claim 48 wherein there is an initial vacuum step of between 0 and −50 kPa.

55: The process as claimed in claim 48 wherein there is a pressure (air pressure) step of between 0 and 100 kPa.

56: The process as claimed in claim 54, wherein the vacuum is held for between 0 and 10 minutes.

57: The process as claimed in claim 55 wherein the pressure is held for between 0 and 10 minutes.

58: The process as claimed in claim 48 wherein timber or product at commencement of the process and prior to any vacuum step is at a moisture content of less than 30% w water/w dry timber or product.

59: The process as claimed in claim 58 wherein the moisture content is less than 20% w water/w dry timber or product.

60: The process as claimed in claim 58 wherein the timber or product has been subject to kiln drying.

61: The process as claimed in claim 48 wherein the composition comprises or includes
water as at least the primary liquid carrier
optionally at least one other liquid
optionally a wetting agent or surfactant
at least one biocidal or other timber protecting agent dissolved in, suspended in and/or emulsified in the water carrier.

62: The process as claimed in claim 48 wherein the concentration of the composition is set at such a level that at the end of a treatment cycle, based on the uptake of composition achieved by the cycle used, the retention of active ingredient or ingredients is higher than the minimum level required to prevent timber or product degradation.

63: The process as claimed in claim 48 wherein the composition is a boron solution, the solution concentration being of about 16% m/v (BAE basis) with an average uptake of 40 L/m³ to ensure at least the required retention level of 0.4% m/m as required by NZS 3640.

64: The process as claimed in claim 48 wherein the time the composition is in contact with the timber or product is from 1 to 10 minutes.

65: The process as claimed in claim 48 wherein the composition has water as at least the majority solvent component for a fungicide or insecticide, or both.

66: The process as claimed in claim 48 wherein preservative is made available to the timber or product at pressures between −50 kPa and +100 kPa.

67: The process as claimed in claim 48 wherein the treated timber or product at the completion of the treatment process has a moisture content of less than 25% w water/w dry timber or product.

68: The process as claimed in claim 67 wherein the end of treatment moisture content is less than 20% w water/w dry timber or product.

69: The process as claimed in claim 48 wherein dimensional changes between the timber or product prior to and post the treatment are no greater than 2 mm in any or either cross-sectional dimension.

70: The process as claimed in claim 48 wherein a vacuum is applied or reapplied (“the final vacuum”) when the timber or product is no longer exposed to the composition.

71: The process as claimed in claim 70 wherein the final vacuum is between 0 and −95 kPa held for from 0-60 minutes.

72. The process as claimed in claim 48 wherein the liquid based biocidal and/or preservative composition includes glycol but the majority of all liquid present is water.

73: A method of protecting wood, lumber or timber (“material”), which comprises or includes
subjecting the material to be treated to at least a partial vacuum, and
exposing the material to an aqueous effective treatment composition at a pressure or pressures of at least about atmospheric pressure or above,
(and optionally subjecting the material, when no longer to external exposure to such composition, to at least a partial vacuum);
wherein the exposure is such that there is an uptake of less than 80 L/m³ of the aqueous composition;
and wherein the aqueous composition has water as its main liquid component but also includes a wetting agent or surfactant and/or another liquid.

74: The method as claimed in claim 73 wherein the uptake is less than 40 L/m³).

75: The method as claimed in claim 73 wherein said composition is biocidal.

76: The method as claimed in claim 75 wherein the composition has an antifungal species in a water carrier.

77: The method as claimed in claim 76 wherein the composition includes at least one other liquid.

78: The method as claimed in claim 76 wherein the composition includes a wetting agent or surfactant.

79: The method as claimed in claim 73 wherein the composition does not include any resin nor curing agent.

80: The method as claimed in claim 73 wherein the exposure to the composition is a single exposure.

81: The method as claimed in claim 73 wherein the exposure is multiple exposures.

82: The method as claimed in claim 73 wherein the composition has a fungicidal active selected from a boron based active, CCA, ACQ, azoles, oxine copper, IPBC, tributyltin, copper or zinc naphthenate, or any combination of any such actives.

83: The method as claimed in claim 82 wherein the active is a boron active.

84: The method as claimed in claim 82 wherein the active is an ACQ active.

85: The method as claimed in claim 73 wherein the composition has the insecticidal active selected from a synthetic pyrethroid (such as permethrin, deltamethrin, cypermethrin or bifenthrin) or imidachloprid, any combination thereof.

86: The method as claimed in claim 73 wherein the material being treated is dimensioned wood, dimensioned lumber or dimensioned timber and the resultant moisture content is less than 20% w water/w dry material after treatment so as to maintain the dimensions of the material treated to substantially those immediately prior to treatment.

87: The method as claimed in claim 73 wherein the material being treated both prior to and post exposure is at less than 20% w water/w dry material.

88: The method as claimed in claim 73 wherein impregnation is of a conifer species wood.

89: The method as claimed in claim 88 wherein the wood is of a pine.

90: The method as claimed in claim 89 wherein the pine is one of Radiata, Slash, Hoop and Southern Yellow.

91: The method as claimed in claim 88 wherein the wood is of Douglas fir or spruce.

92: The method as claimed in claim 73 wherein uptake achieves an H3 loading of about 0.45% m/m in the cross section.

93: The method as claimed in claim 73 wherein the concentration of active and actives chosen for the uptake of liquid which is the carrier therefor will result in retention levels of the active(s) in the material above the minimum required to protect the timber against decay, insect and, where required, termite attack.

94: The method as claimed in claim 73 wherein glycol is present as part of the liquid content of the aqueous treatment composition.

95: A product or timber that has been subject to the process as claimed in claim 48.

96: A material that has been subject to the process as claimed in claim 73.
